(19) United States
(12) Patent Application Publication
(10) Pub. No.: US 2008/0053252 A1
(43) Pub. Date: Mar. 6, 2008

(54) PORTAL TRACE DETECTION SYSTEMS FOR DETECTION OF IMBEDDED PARTICLES

(76) Inventors: Anthony Jenkins, North Reading, MA (US); William J. McGann, Raynham, MA (US); Kevin J. Perry, Pelham, NH (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/934,155

(22) Filed: Nov. 2, 2007

Related U.S. Application Data
(63) Continuation of application No. 11/032,613, filed on Jan. 10, 2005, now abandoned.
Application No. 11/032,613 is a division of application No. 10/774,004, filed on Feb. 6, 2004, now Pat. No. 6,840,122.
Application No. 10/774,004 is a division of application No. 10/033,874, filed on Dec. 20, 2001, now Pat. No. 6,708,572.

(51) Int. Cl. G01N 1/00

(52) U.S. Cl. 73/864.33

(57) ABSTRACT

A portal trace detection apparatus is provided for detecting minute particles of interest, such as traces of narcotics, explosives and other contraband. The apparatus includes a portal through which a human suspect will pass. A detection apparatus is disposed at least partly in the ceiling of the portal, and hence above the human subject in the portal. Particles of interest will be entrained in the human thermal plume that exists in the boundary adjacent the suspect, and will flow upwardly from the suspect to the detection apparatus in the ceiling of the portal. The ceiling is coated with an anti-static material so that particles are more likely to flow towards the detector and less likely to be affixed electrostatically to the ceiling.

### RELATED APPLICATIONS

This application is a continuation of U.S. patent application Ser. No. 11/032,613 filed 10 Jan. 2005, which is a divisional of U.S. patent application Ser. No. 10/774,004 filed Feb. 6, 2004, now issued as U.S. Pat. No. 6,840,122, which is a divisional of U.S. patent application Ser. No. 10/033,874, filed Dec. 20, 2001, now issued as U.S. Pat. No. 6,708,572.

### BACKGROUND OF THE INVENTION

1. Field of the Invention

The subject invention relates to a detection apparatus for dislodging particles from clothing and skin of a person and then testing the dislodged particles for the presence of substances of interest.

2. Description of the Related Art

Detection systems exist for detecting traces of materials, such as narcotics and explosives. Such systems are marketed by Ion Track Instruments, Inc. and are shown, for example, in U.S. Pat. No. 5,491,337.

Prior art detection systems rely upon the fact that trace amounts of contraband will be transferred to the body of a person who handled the contraband, and subsequently will be transferred from the body to any article that the person may carry. These trace amounts of contraband may be collected for analysis by wiping a small sheet of appropriate material across a purse, suitcase or other article that has been handled by a suspect. The prior art sheet then is inserted into a prior art detection apparatus which tests for the presence of certain contraband.

Attempts have been made to provide such contraband testing without physically contacting the suspect or articles that the suspect may be transporting. Several such prior art devices employ a portal through which the suspect will walk. Most of these prior art devices create a flow of air in the portal in an effort to entrain the particles of interest in a continuously flowing air stream. The air stream then is directed to a detector which attempts to identify the presence of particles of interest. Unfortunately, the prior art apparatus draws a significant volume of air from outside the portal, and hence substantially dilutes the concentration of particles of interest in the air stream that is directed to the detector.

U.S. Pat. No. 6,073,499 shows a recent improvement with respect to portals for detecting the presence of contraband on a suspect. More particularly, U.S. Pat. No. 6,073,499 discloses a portal detection system that relies upon the fact that a boundary of air adjacent to a human being is heated by the body. The heated air in this boundary layer is less dense than air further from the suspect, and hence will flow upwardly. Thus, a human thermal plume is created naturally around the human suspect. Particles of interest will be entrained in this thermal plume and will rise upwardly around the body. The portal system shown in U.S. Pat. No. 6,073,499 relies upon this natural phenomena by providing a fan or other air flow generator at a location above the suspect and operating at a speed to substantially match the airflow rate of the naturally-occurring human thermal plume. Thus, the fan or other such device shown in U.S. Pat. No. 6,073,499 merely directs the naturally occurring human thermal plume to a detector without drawing significant volumes of ambient air into the detector. Thus, the concentration of particles of interest is significantly higher than the concentration in prior art portals that create a significant artificial airflow in an effort to entrain and transport the particles of interest.

The prior art detection portal disclosed in U.S. Pat. No. 6,073,499 is particularly effective for detecting trace amounts of contraband that may have been deposited on the skin of a suspect. However, microscopic particles of contraband also are very likely to be trapped in the clothing of a suspect. The natural thermal plume existing in the boundary layer surrounding a human suspect may not be capable of dislodging particles of interest from the clothing. Of course, most of a human suspect will be covered by clothing. Hence, the efficiency of the system disclosed in U.S. Pat. No. 6,073,499 may be limited somewhat by the tendency of particles of interest to be trapped in the clothing of the human suspect passing through the portal.

Some prior art systems, including the system shown in U.S. Pat. No. 6,073,499 suggest the use of air jets to dislodge particles of interest from clothing. However, air jets can create turbulence that may disrupt the efficient upward flow of air in the natural thermal plume surrounding the human suspect. Additionally, air jets have the potential of creating air flow patterns that will draw significant volumes of air from the ambient surroundings, thereby reducing the concentration of the particles of interest in the flow of air directed to the detector.

In view of the above, an object of the subject invention to provide a portal trace detection system that is capable of detecting embedded particles, such as particles embedded in clothing of a human suspect passing through the portal.

### SUMMARY OF THE INVENTION

The subject invention is directed to a portal detection system that relies primarily upon the upwardly flowing human thermal plume. The portal includes an inspection apparatus with an inlet disposed above the area of the portal where the human suspect will stand. The inlet may be in communication with a fan or other such device for generating an air flow. Preferably, the fan or other such apparatus will operate to generate an air flow that substantially matches the air flow rate in a typical human thermal plume. For example, the air flow rate in close proximity to the human body is approximately 0.5 meter per second, and the fan may function to substantially match this air flow speed and volumetric rate of flow.

The portal of the subject invention may be similar to the portal shown in U.S. Pat. No. 6,073,499 in most relevant respects. However, the portal of the subject invention is supplemented by a plurality of air jets disposed at locations that will extend approximately from knee level to chest level of a typical human subject passing through the portal. Tests have shown that this area of the body carries most contamination after handling a contraband material.

The array of air jets preferably comprises a plurality of vertical lines of air jets disposed at a plurality of different sides on the portal and directed inwardly and upwardly in the portal. For example, four vertical lines of air jets may be disposed respectively at the corners of the portal. The air jets in each line may be separated from one another by about 300 mm, and preferably are aligned to the vertical at an angle of between 30°-60°.

The jets may be connected to a high pressure (40-100 psi) air supply and may be operated sequentially by solenoid valves that are connected to and operated by a controller. Each jet is operative to deliver a short puff of air which disturbs the clothing of the human suspect sufficiently to release trapped particles. The air flow created by the jets necessarily disturbs the body plume somewhat, and hence conceivably could cause a turbulence that could direct particles of interest out of the portal. However, the effect of the jets on the human thermal plume can be minimized substantially by operating each jet only for a very short duration. Thus, each jet functions essentially like a smoke ring with a local disturbance, but a minimum effect on air flow patterns in the human thermal plume. Furthermore, the effect of the short puffs of air produced by the jet can be used cooperatively with the human thermal plume by actuating the jets sequentially from bottom to top in each of the vertical arrays of jets. The jets preferably are switched on for about 10-80 ms, and each level of jets is switched off before the next level is switched on. It has been determined that longer periods of operation for the respective jets adversely affects the human thermal plume without significantly increasing the release of particles from the clothing of the human suspect passing through the portal.

The portal apparatus of the subject invention provides still a further advantage. In particular, it has been determined that small dander particles that are given off from the skin gradually migrate into the clothing. These dander particles can act as vapor traps for very low volatility materials, such as explosives and narcotics which may be hidden under the clothing of under the human subject passing through the portal. These dander particles are released by the jets, and hence become entrained in the human thermal plume. More particularly, the dander particles effectively become tiny traps that are released by the jets and transported in the human thermal plume to the detection system where the trapped vapors are desorbed. Thus, the incorporation of the jets into the portal detection system creates the possibility of detecting vapors that normally would be below the threshold of sensitivity of the system.

It also has been determined that particles of interest often affix themselves to the hood or ceiling of the portal due to static electricity, in much the same way that dust accumulates on a television screen. This phenomenon can be reduced or eliminated by coating the hood or ceiling with an anti-static material. Thus, fewer particles become affixed to the hood, and sensitivity is increased.

### BRIEF DESCRIPTION OF THE DRAWINGS

FIG. 1 is a front view of a portal detection apparatus in accordance with the subject invention.

FIG. 2 is a cross-sectional view taken along line 2-2 in FIG. 1.

### DETAILED DESCRIPTION OF THE PREFERRED EMBODIMENT

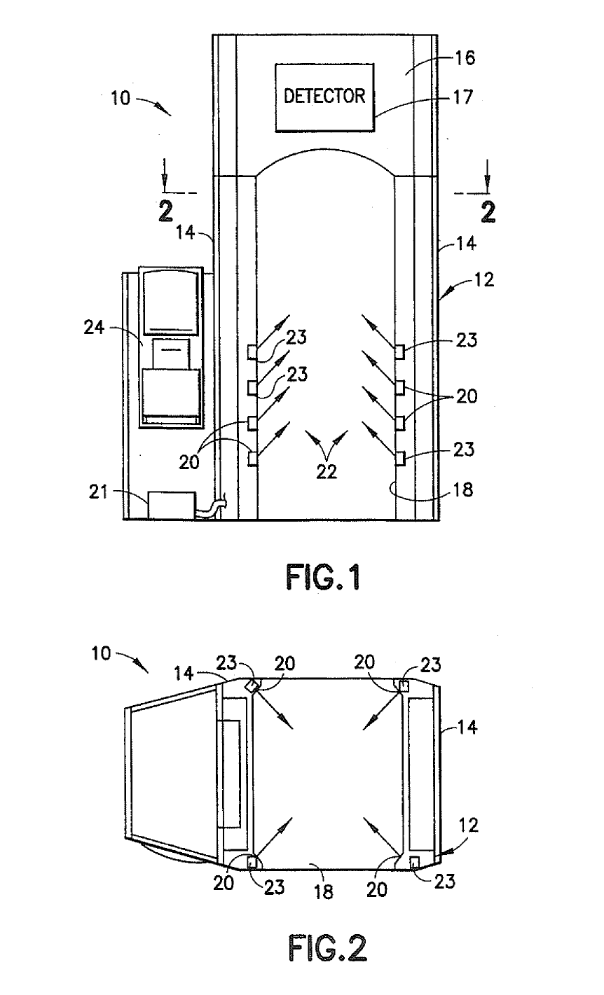

A portal detection system in accordance with the subject invention is identified generally by the numeral 10 in FIGS. 1 and 2. The portal detection system 10 is similar to the portal detection system disclosed in U.S. Pat. No. 6,073,499. In particular, the portal detection system 10 includes a portal 12 having a plurality of sidewalls 14, a plastic ceiling or hood 16 and a passage 18 extending between the sidewalls 14 and beneath the ceiling 16. The ceiling 16 preferably is made from or coated with an anti-static material such as KYDEX T as manufactured by Kleerdex. The anti-static material reduces or eliminates the electrostatic accumulation of particles of interest on the ceiling, and hence improves sensitivity. The ceiling 16 includes an inlet with a fan for producing an air flow that substantially matches the air flow rate provided by the human thermal plume. The ceiling 16 further includes at least portions of detection system 17. The detector of the subject invention is not disclosed herein. However, the detector may be an ion trap mobility spectrometer as disclosed in U.S. Pat. No. 5,491,337. Additionally, various structural and operational features of the portal 12 are as disclosed in U.S. Pat. No. 6,073,499. The disclosures of these two patents are incorporated herein by reference.

The apparatus 10 of FIGS. 1 and 2 further includes a plurality of air jets 20. The jets are arranged to define four linear jet arrays 22 with the jets 20 in each array 22 being vertically aligned. The jets 20 preferably are disposed in the portal 12 to extend from a lower location approximately at knee level (e.g., 1-2 feet from the ground) to an upper location approximately at chest level (e.g., 4-5 feet from the ground). Each jet 20 is disposed to direct a short puff of air inwardly and upwardly into the passage 18 of the portal 12. More particularly, as shown most clearly in FIG. 1, the jets 20 are aligned at an acute angle of approximately 30°-60° to the vertical. The jets communicate with a supply of high pressure air in the range of 40-100 psi and preferably 80 psi. The jets include solenoid valves that communicate with and are controlled by a controller 24 to operate sequentially. More particularly, the controller 24 functions to fire the respective jets 20 sequentially from bottom to top. Each jet 20 is switched on for about 10-100 ms, and preferably about 50 ms. Each jet 20 then is switched off for about 100 ms before the next higher jet 20 is switched on. The jets 20 function to disturb the clothing of the human subject in the passage 18 sufficiently to dislodge particles of interest that may be trapped in the clothing of the suspect. However, the short puffs of air are controlled to achieve minimum disruption and minimum dilution of the human thermal plume. The dislodged particles then are entrained in the human thermal plume that exists adjacent the human subject. The air in the human thermal plume, including the particles of interest that are dislodged from the clothing are directed to the detector substantially as disclosed in U.S. Pat. No. 6,073,499.

In use, the suspect is instructed to enter the portal 12. Visual signals or voice prompts will ask the suspect to remain in the portal 12 for about 5-10 seconds. The jets 20 will then fire sequentially from bottom to top. More particularly, the four lower tier jets 20 will fire simultaneously for about 50 ms. There then will be a pause of about 100 ms, and the four jets 20 in the second tier will fire for about 50 ms. This process will continue until the four jets 20 in the tip tier have fired. Particles displaced by the jets 20 will be entrained in the human thermal plume and will flow naturally upward through the hood-shaped ceiling 16. After about 5-10 seconds, the suspect will be instructed to exit the portal 12.

What is claimed is:

1. A trace detection system, comprising:
a walkthrough portal having sidewalls and a ceiling that form a passage;
one or more jets each configured to direct a puff of air into the passage; and
a detection apparatus having an inlet in communication with the passage, the detection apparatus configured to detect a presence of a substance of interest included in air from the passage.

2. The trace detection system of claim 1, wherein each of the one or more jets is configured to dislodge one or more particles from a subject in the passage.

3. The trace detection system of claim 1, wherein the dislodged one or more particles comprise the substance of interest.

4. The trace detection system of claim 1, wherein each of the one or more jets is aligned to project inwardly and upwardly into the passage of the portal.

5. The trace detection system of claim 1, further comprising a controller configured to control operation of each of the one or more jets.

6. The trace detection system of claim 5, wherein the controller is operative for injecting bursts of air sequentially from jets at lower locations to jets at upper locations.

7. The trace detection system of claim 2, wherein at least a surface of the ceiling that faces into the passage comprises an anti-static material configured to prevent electrostatic accumulation of the dislodged one or more particles.

8. The trace detection system of claim 1, wherein the ceiling comprises a plastic material coated with the anti-static material.

9. The trace detection system of claim 1, wherein the ceiling is formed from the anti-static material.

10. The trace detection system of claim 1, wherein the ceiling includes a concave surface facing into the passage.
